(19) United States
(12) Patent Application Publication
(10) Pub. No.: US 2020/0226632 A1
(43) Pub. Date: Jul. 16, 2020

(54) METHODS AND SYSTEMS FOR PROVIDING CONTEXTUALIZED, PERSONALIZED PRICING, OFFERS, AND RECOMMENDATIONS

(71) Applicant: Omnyway, Inc., San Mateo, CA (US)

(72) Inventors: Mohammad Khan, San Jose, CA (US); Ashok Narasimhan, San Francisco, CA (US); William N. Melton, San Francisco, CA (US)

(21) Appl. No.: 16/628,883

(22) PCT Filed: Jul. 6, 2018
(86) PCT No.: PCT/US2018/041025

§ 371 Date: Jan. 6, 2020

Related U.S. Application Data
(60) Provisional application No. 62/529,090, filed on Jul. 6, 2017.

(51) Int. Cl. G06Q 30/02; G06Q 30/06; G06N 5/02

(52) U.S. Cl. CPC G06Q 30/0226; G06N 5/02; G06Q 30/0631

(57) ABSTRACT

Methods, systems, and computer readable media for providing contextualized, personalized pricing, offers, and recommendations to a user are disclosed. According to one aspect of the present disclosure, a method for providing contextualized, personalized pricing, offers, and recommendations to a user comprises identifying and collecting contextual information of interest, identifying algorithms, expert knowledge rules, and/or filters to apply to the contextual information of interest, and applying the identified algorithms, expert knowledge rules, and/or filters to the contextual information of interest to generate a contextualized price, offer, or recommendation.

### RELATED APPLICATIONS

This application claims the benefit of U.S. provisional patent application Ser. No. 62/529,090, filed Jul. 6, 2017, the disclosure of which is hereby incorporated herein by reference in its entirety.

### TECHNICAL FIELD

This disclosure relates to methods and systems by which merchants can provide potential customers with contextualized, personalized pricing, offers, and recommendations.

### BACKGROUND OF THE INVENTION

Historically, the majority of customers that enter a store or visit a merchant premises do not buy anything during the store visit. That is, the percentage of visiting customers who purchase something during the store visit is low. With the advent of ubiquitous internet access, e.g., via cellphones or other mobile devices, that percentage continues to drop. Customers in a physical store who see an item which they may be interested in purchasing can instantly compare prices for that item, e.g., that store's price versus another physical store's price or the price offered by an online retailer; if the customer can get the item for less from another store or from an online retailer, that person is even less likely to make a purchase during the store visit. In addition, the rising popularity of online buying has forced physical stores to reduce their overhead costs, which typically includes a reduction in the number of people employed in their sales forces.

Thus, even though customers who have interactions with sales staff are more likely to make a purchase, more likely to make additional purchases, and more likely to purchase a more expensive version of an item than customers who do not have interactions with a salesperson, stores nevertheless are reducing their sales force. As a result, visitors to physical stores find it increasingly difficult to get sales help when they need it, which makes it even more likely that the customer will leave the store premises in frustration without having made a purchase. All of these factors are reducing the likelihood that a potential customer will make a purchase during a store visit.

Merchants also have a tremendous disadvantage—namely, that, unless a customer actually makes an in-store purchase, the merchant has no way to know that the customer is in the store at all. Until a customer makes an in-store transaction, merchants have no means to know how many customers are within the store, who those customers are, or what those customers want. As a result, even a customer who is highly motivated to make a purchase could enter the store, fail to find an item of interest, fail to get help from sales staff, and leave the store, all without the merchant's knowledge. The merchant has no opportunity to provide the personal attention that would facilitate a purchase as well as encourage additional purchases.

Accordingly, there is a need for new ways to provide potential customers with contextualized, personalized pricing, offers, and recommendations.

### SUMMARY OF THE INVENTION

The subject matter disclosed herein includes methods and systems for providing contextualized, personalized pricing, offers, and recommendations to a user.

According to one aspect of the present disclosure, a method for providing contextualized, personalized pricing, offers, and recommendations to a user comprises: identifying and collecting contextual information of interest; identifying algorithms, expert knowledge rules, and/or filters to apply to the contextual information of interest; applying the identified algorithms, expert knowledge rules, and/or filters to the contextual information of interest to generate a contextualized price, offer, or recommendation; and providing or presenting the contextualized price, offer, or recommendation to the user.

In some embodiments, the contextual information of interest comprises information determined to be pertinent or potentially pertinent to the user.

In some embodiments, the contextual information of interest comprises user profile information.

In some embodiments, the user profile information includes prior history of interest, preferences, purchasing data, and/or shopping behavior of the user. For example, a user's profile may indicate whether a user will respond positively to (e.g., take advantage of or change shopping preferences in response to) a 10% discount offer or whether the user must be offered a 30% discount before that user will make a purchase. In other examples, a user's profile may indicate whether or not a user responds to product recommendations, or whether the user purchases products for himself or herself, or only or for others (e.g., family, friends, etc.)

In some embodiments, the user profile information includes current indications of interest of the user.

In some embodiments, the contextual information of interest comprises information about past, present, or projected climate or weather conditions associated with the user's past, present, or projected location.

In some embodiments, the contextual information of interest comprises information about personal events (e.g., birthdays, anniversaries, special occasions, social events, professional events, etc.).

In some embodiments, the contextual information of interest comprises information about public events (e.g., holidays, election days, sports events, concerts, film or theater productions, etc.).

In some embodiments, the contextual information of interest comprises information about natural or emergency events (e.g., flash floods, fires, earthquakes, hurricanes, etc.).

In some embodiments, the contextual information of interest comprises information about the state of product inventory and/or available promotions. Product inventory could be inventory available in store as well as in other stores or warehouses. The systems and methods described herein allow a user to purchase items in the store as well as in other stores or warehouses in a single transaction; the user may take items available in store with him or her while the other items are shipped to the user's home or other location specified by the user.

In some embodiments, the available promotions are relevant to, associated with, and/or filtered by other contextual information.

In some embodiments, the contextual information of interest comprises information about a state of customer loyalty to a seller (e.g., a number of seller or third party loyalty points, rewards, and or promotion cash available to be redeemed).

In some embodiments, the contextualized, personalized pricing, offers, and recommendations includes an original sale price and at least one of: discounts available to all customers; loyalty points, rewards, and promotion cash available to the user; and/or a special surprise offer generated in real-time based on contextual information and identified algorithms.

According to another aspect of the present disclosure, a system for providing contextualized, personalized pricing, offers, and recommendations to a user comprises one or more processors, and memory storing instructions executable by the one or more processors. The system is operable to: identify and collect contextual information of interest; identify algorithms, expert knowledge rules, and/or filters to apply to the contextual information of interest; apply the identified algorithms, expert knowledge rules, and/or filters to the contextual information of interest to generate a contextualized price, offer, or recommendation; and provide or present the contextualized price, offer, or recommendation to the user.

In some embodiments, the contextual information of interest comprises information determined to be pertinent or potentially pertinent to the user.

In some embodiments, the contextual information of interest comprises user profile information.

In some embodiments, the user profile information includes prior history of interest, preferences, purchasing data, and shopping behavior of the user.

In some embodiments, the contextual information of interest comprises information about past, present, or projected climate or weather conditions, which may or may not be associated with the user's past, present, or projected location.

In some embodiments, the contextual information of interest comprises information about personal events, birthdays, anniversaries, special occasions, social events, public events, holidays, election days, professional events, sports events, performances, and/or social events.

In some embodiments, the contextual information of interest comprises information about natural or emergency events (e.g., flash floods, fires, earthquakes, hurricanes, etc.).

In some embodiments, the contextual information of interest comprises state of product inventory and/or available promotions.

In some embodiments, the available promotions are relevant to, associated with, and/or filtered by other contextual information.

In some embodiments, the contextual information of interest comprises information about a state of customer loyalty to a seller (e.g., a number of seller or third party loyalty points, rewards, and or promotion cash available to be redeemed).

In some embodiments, the contextualized, personalized pricing, offers, and recommendations includes an original sale price and at least one of: discounts available to all customers; loyalty points, rewards, and promotion cash available to the user; and/or a special surprise offer generated in real-time based contextual information and identified algorithms.

According to another aspect of the present disclosure, a system for providing contextualized, personalized pricing, offers, and recommendations to a user is adapted to: identify and collect contextual information of interest; identify algorithms, expert knowledge rules, and/or filters to apply to the contextual information of interest; apply the identified algorithms, expert knowledge rules, and/or filters to the contextual information of interest to generate a contextualized price, offer, or recommendation; and provide or present the contextualized price, offer, or recommendation to the user.

According to another aspect of the present disclosure, a system for providing contextualized, personalized pricing, offers, and recommendations to a user comprises one or more modules operable to: identify and collect contextual information of interest; identify algorithms, expert knowledge rules, and/or filters to apply to the contextual information of interest; apply the identified algorithms, expert knowledge rules, and/or filters to the contextual information of interest to generate a contextualized price, offer, or recommendation; and provide or present the contextualized price, offer, or recommendation to the user.

According to another aspect of the present disclosure, a non-transitory computer readable medium stores software instructions that, when executed by one or more processors of a system for providing contextualized, personalized pricing, offers, and recommendations to a user, cause the system to identify and collect contextual information of interest; identify algorithms, expert knowledge rules, and/or filters to apply to the contextual information of interest; apply the identified algorithms, expert knowledge rules, and/or filters to the contextual information of interest to generate a contextualized price, offer, or recommendation; and provide or present the contextualized price, offer, or recommendation to the user.

According to another aspect of the present disclosure, a computer program comprises instructions which, when executed by at least one processor, cause the at least one processor to carry out any of the methods disclosed herein.

According to another aspect of the present disclosure, a system for providing contextualized, personalized pricing, offers, and recommendations to a user comprises one or more processors and memory storing instructions executable by the one or more processors, whereby the system is operable to: identify and collect contextual information of interest; identify algorithms, expert knowledge rules, and/or filters to apply to the contextual information of interest; apply the identified algorithms, expert knowledge rules, and/or filters to the contextual information of interest to generate personalized information that comprises a personalized price that includes original sale price, discounts available to all customers, loyalty points, rewards, and promotion cash redeemed, and a special contextual offer generated based on the contextual information of interest and identified algorithms; and provide or present the personalized information to the user.

In some embodiments, identifying and collecting contextual information of interest comprises identifying direct information of interest; identifying profile and prior history of interest; identifying a recent, current, or forecasted state of events related to weather, climate, personal events, social events, sports events, holidays, and/or natural events; identifying a state of inventory and available promotions of one or more products relevant to identified context and state of events; identifying a state of customer loyalty to a seller; and identifying a number of seller or third party loyalty points, rewards, and/or promotion cash available to be redeemed.

In some embodiments, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates an exemplary system for providing contextualized, personalized pricing, offers, and recommendations according to an embodiment of the subject matter described herein.

FIG. 2 is a flow chart illustrating an exemplary process for providing contextualized, personalized pricing, offers, and recommendations according to another embodiment of the subject matter described herein.

FIG. 3 illustrates an exemplary system for providing contextualized, personalized pricing, offers, and recommendations according to yet another embodiment of the subject matter described herein.

FIG. 4 illustrates an exemplary system for providing contextualized, personalized pricing, offers, and recommendations according to yet another embodiment of the subject matter described herein.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

Due to several factors, including increasing financial pressure from online retailers, the percentage of visitors to a physical store that purchase an item during that visit is dropping. In response to that financial pressure, many physical stores have reduced the number of salespeople present at any one time. As a result, visitors to physical stores find it increasingly difficult to get sales help when they need it, which makes it even more likely that the customer will leave the store premises in frustration without having made a purchase.

To address these factors, the subject matter of the present disclosure includes methods and systems for providing instant, in-store, personalized incentives and/or out-of-store services to customers during a store visit. The solutions provided herein include, but are not limited to, providing a platform by which a retailer can have their own application, hosted by a cellphone or other computing device of the user, that provides such incentives and services.

The solutions disclosed herein can do more than merely effect a purchase. The methods and systems disclosed herein can help a customer find an item within the store, help a customer find an item in their size or in a particular color, make suggestions about additional products that would complement the desired item, give personal opinions about the item or other information that would assist the customer to make a decision, make the customer aware of sales, discounts, or other incentives, and provide other helpful services.

Many customers prefer in-store shopping over on-line shopping because can get a better idea about the size, quality, and fit (of clothing, for example) of an item if they see and touch it in person. A common complaint, however, is that after taking the time to go to the physical store and finding an item that they want to buy, the store doesn't have the item in the customer's size, or worse—the physical store's system says that there is such an item in the store somewhere but the sales staff can't find it in the store.

The methods and systems disclosed herein solve this problem by providing the customer the ability to purchase something that is not currently available in the store. For example, if a customer wants to buy an article of clothing but can't find that article in the right size, color, style, etc., the customer could use a smart phone application to order the item in the right size, pay for the item, and have the item automatically shipped from the store warehouse, other store, etc., directly to the customer's home. In this manner, the customer can complete the purchase easily while still in the physical store and continue shopping, secure in the knowledge that he or she will be able to complete the purchase to his or her satisfaction while still in the physical store, whether or not the physical store has that particular item in stock.

The methods and systems disclosed herein can also: order the item from another store; have the item shipped from a warehouse to the store, to another store, or to the customer's home; suggest alternatives that the customer may also like; offer a discount or gift card for the customer to use in order to encourage the customer to return to the store; and otherwise present to the customer other instant, in-store, personalized incentives and/or out-of-store services.

### Contextualization

Contextualization is the process of determining contextual information about entities involved in the process as well as the environment. Contextual information may include, but is not limited to, information about the shopper, information about the merchant, information about the environment.

Information about the shopper may include, but is not limited to: shopper identity; personal preferences; purchasing history; rewards or club membership status; incentives (e.g., coupons, rewards cards, discounts, etc.) received, used, and/or accumulated; current location; current mobility; whether the shopper is in a store or merchant premises; shopper location within the store; whether the shopper is in a physical store versus an online store or a virtual reality (VR) store; and indicia of interest in items.

Indicia of interest may be determined or inferred from a variety of actions or behaviors, including, for example, a determination that a shopper is looking at a specific product. Interest in a specific product may be based on: in-store or online search, price check, or purchase history; in-store location; time spent in a particular section of a store; time spent viewing or handling a particular item or class of items; actions, body language, or facial expression; and others. For example, if a shopper scans a UPC/QR/barcode using a mobile device or an in-store price-lookup kiosk or scans an image of a product using a cellphone, it may be inferred that the shopper is interested in that specific product. If it is detected that a shopper is spending time near a particular item or in a particular area, e.g., the shopper's cell phone detects proximity to a Near Field Communication (NFC) device or Bluetooth™ beacon, or the shopper's location can be determined or inferred using LiFi or other triangulation schemes, interest in particular products or categories of products may be inferred.

Information about the merchant may include, but is not limited to: identity of merchant; location of physical store(s); merchant- or manufacturer-provided incentives, sales, specials, rebates, coupons, etc., currently available; numbers of items in stock at a store or warehouse; availability of an item from the manufacturer or distributor; item popularity, ratings, or trends; item availability or scarcity; and others.

Information about the environment may include, but is not limited to: current date, time, or day of the week; whether the current day is a holiday or birthday; current weather conditions (sunny or cloudy, air temperature, air pressure, wind speed, precipitation, etc.); noise levels; population or crowd density; and so on.

Contextual information may be received from, provided to, or processed by a wide variety of sources, including, but not limited to: cellphones or other mobile devices; digital signage; kiosks; video or still images; Point Of Sale (POS) terminals; product information or images inserted into a television show, movie, live performances, etc.; Bluetooth™ beacons; Radio Frequency Identification Devices (RFID); Near Field Communications (NFC) devices; wireless transmissions; security/surveillance cameras; etc.

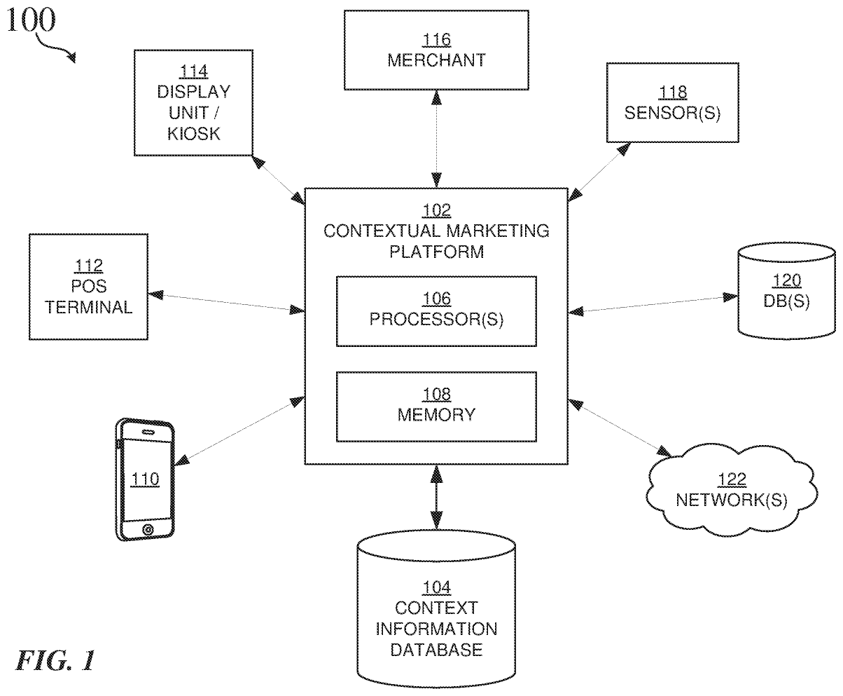

FIG. 1 is a block diagram illustrating an exemplary system for providing contextualized, personalized pricing, offers, and recommendations according to an embodiment of the subject matter described herein. In the embodiment illustrated in FIG. 1, system 100 includes a contextual marketing platform 102 and a context information database 104 for storing contextual information. In the embodiment illustrated in FIG. 1, the contextual marketing platform 102 includes processing circuitry comprising one or more processors 106, e.g., Central Processing Units (CPUs), Application Specific Integrated Circuits (ASICs), Field Programmable Gate Arrays (FPGAs), Digital Signal Processors (DSPs), and/or the like, and memory 108 for storing instructions executable by the one or more processors 106, whereby the system 100 is operable to analyze contextual information associated with a shopper, generate a contextualized price, contextualized offer, and/or contextualized product recommendation, personalized for that particular shopper, and provide or present that contextualized price, contextualized offer, and/or contextualized product recommendation to the shopper. In some embodiments, the functionality of the contextual marketing platform 102 described above may be fully or partially implemented in software that is, e.g., stored in the memory 108 and executed by the processor(s) 106. It will be understood that the shopper may be the user of the system, in which case the terms “shopper” and “user” are synonymous with each other.

In one embodiment, the contextualized, personalized pricing, offers, and/or product recommendations may be provided to the shopper via the shopper's mobile device 110, via a Point Of Sale (POS) terminal 112, via a display unit 114, such as a kiosk, or via any other suitable vehicle or mechanism, including, but not limited to, television programs, movies, video games, live entertainment, and others. In one embodiment, contextual marketing platform 102 may receive contextual information from a variety of sources, including, but not limited to, from the shopper's mobile device 110, from a merchant 116, from sensors 118, from other databases 120, from a telecommunications or data network 122, or other source of contextual information.

Examples of sensors 118 and sensor-provided data include, but are not limited to, barcode or QR code scanners, beacons, LiFi, Location Based Services (LBS), mobile phone cameras, in-store premises cameras, Near Field Communication (NFC) devices, Bluetooth™ devices, WiFi or Radio Frequency (RF) triangulations, capacitive sensors, touch sensors, pressure sensors, proximity sensors, and other technologies that detect a user's position, movement, speed, etc. Other sensor input can include, but is not limited to, facial recognition technologies, including those used for identification of an individual and those used for identification of emotional state, voice analysis data, and behavior analysis data. All of these types of information may be used, for example, to try to gauge a shopper's interest in a particular item or class of items, to predict shopper behavior in order to make available pertinent incentives and/or draw attention to items that are likely to be of interest, and so on.

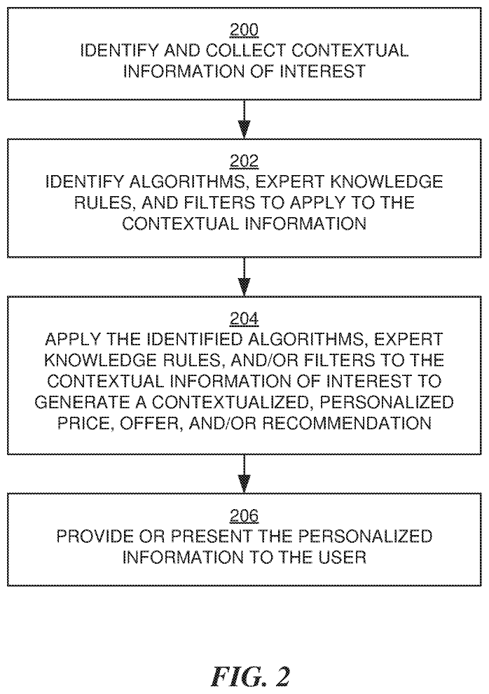

FIG. 2 is a flow chart illustrating an exemplary process for providing contextualized, personalized pricing, offers, and recommendations according to another embodiment of the subject matter described herein. In the embodiment illustrated in FIG. 2, the process includes: identifying and collecting contextual information of interest (step 200); identifying algorithms, expert knowledge rules, and/or filters to apply to the contextual information (step 202); applying the identified algorithms, knowledge rules, and/or filters to the contextual information of interest to generate a contextualized price, offer, or recommendation (step 204); and providing or presenting the personalized information to the user (step 206).

Contextual information of interest may refer to not only contextual information that is of interest to the algorithms and rules that are used to generate the contextualized, personalized pricing, offers, and recommendations, but also to contextual information that indicates a shopper's interest in a particular item. The latter could be collected, for example, through a user specific action, e.g., reading UPC code of a product with its mobile camera, taking a photo of an item, or the interest could be shown through being present in front of a product, shelf or in a specific department of a store, and so on.

In one embodiment, for example, the level of interest that a shopper is showing towards a particular product may be determined from analysis of visuals taken from cameras installed in-store. Motion detection or other types of video analysis software could detect that a shopper has picked up a product, or has picked it up, put it down, and picked it back up again, etc. Facial expression analysis software may detect that the shopper's facial expression indicates interest, excitement, or approval. Behavior analysis software may detect that the shopper has shown the product to a companion, or has behaved in other ways that indicate heightened interest, such as that the shopper has lingered near the product, that the shopper has repeatedly returned to the area where the product is located, and so on. This position information may be determined using other means as well. For example, the shopper may be running an application on his or her mobile device 110 that communicates the shopper's physical location and identity to the merchant 116 and/or the contextual marketing platform 102.

In one example, the process may be triggered when a shopper enters a merchant premises while in possession of a mobile device 110 that is running a merchant-branded application. The application may communicate with the contextual marketing platform 102, e.g., to provide notification that the user of the device is on the premises. Information such as the date, time, specific location, shopper identity, etc., is contextual information that may be stored and/or used by the contextual marketing platform 102 according to rules and/or filters.

For example, the contextual marketing platform 102 may use data from sensors 118 to determine local weather conditions, and use that information to decide whether or not to offer the shopper a special coupon for a cold drink. The contextual marketing platform 102 may provide the shopper ID to the merchant 116, who may then retrieve information about the shopper's history, preferences, etc.; if the shopper has a certain number of loyalty points or regularly spends above some threshold amount, for example, the merchant 116 may choose to give special offers, discounts, or offer other incentives to the shopper. If the shopper browses products using an in-store display unit or kiosk 114, this may be detected by the contextual marketing platform 102, which may use this information to determine what products the shopper may be interested in at the moment and use that information to decide whether or not to offer the particular shopper a special deal on that item, an incentive to purchase that item by itself or as a bundle with another item, and so on.

In short, the contextual marketing platform 102 may use contextual information of a variety of types, received from a variety of sources, applied to a variety of algorithms or rules, to determine what kinds of incentives should be offered to a particular user. The example described above is intended to be illustrative and not limiting.

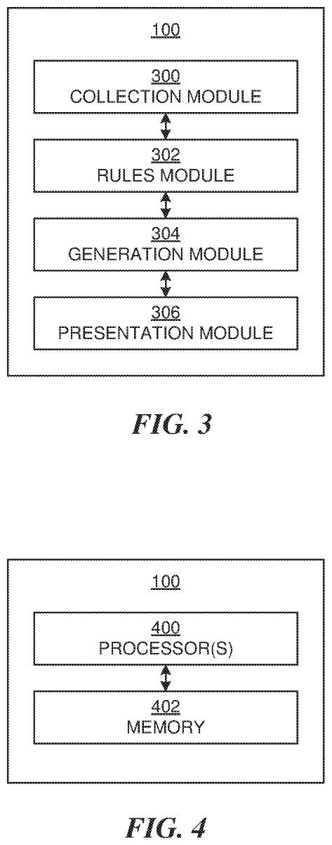

FIG. 3 illustrates an exemplary system for providing contextualized, personalized pricing, offers, and recommendations according to yet another embodiment of the subject matter described herein. In the embodiment illustrated in FIG. 3, system 100 includes a collection module (300) operable to identify and collect contextual information of interest; a rules module (302) operable to identify algorithms, expert knowledge rules, and/or filters to apply to the contextual information of interest; a generation module (304) operable to apply the identified algorithms, expert knowledge rules, and/or filters to the contextual information of interest to generate a contextualized price, offer, or recommendation; and a presentation module 306 for providing or presenting the contextualize price, offer, or recommendation to the user.

FIG. 4 illustrates an exemplary system for providing contextualized, personalized pricing, offers, and recommendations according to yet another embodiment of the subject matter described herein. In the embodiment illustrated in FIG. 4, system 100 includes one or more processors 400 and memory 402 storing instructions executable by the one or more processors 400, whereby the system is operable to: identify and collect contextual information of interest; identify algorithms, expert knowledge rules, and/or filters to apply to the contextual information of interest; apply the identified algorithms, expert knowledge rules, and/or filters to the contextual information of interest to generate a contextualized price, offer, or recommendation; and provide or present the contextualized price, offer, or recommendation to the user.

Having access to contextual information from a wide range of sources and in a wide range of formats allows system 100 to provide at least three distinct features or benefits:

Contextualized price:
a financial incentive that is based on interest in a particular item.

Contextualized offer:
a financial incentive that is based on one or more products that the customer may not be looking at specifically but for which there is inferred interest based on contextual information (e.g., customer location within the store, weather conditions, holidays, etc.)

Contextualized product recommendation:
not necessarily a financial incentive; usually triggered by a request for product information.

Each of these features/benefits will now be discussed in detail, below.

Contextualized Personalized Price with Surprise Offer

In one embodiment, a shopper may be presented with a contextualized personalized price. It should be noted that the terms “contextualized” and “contextual” are used interchangeably—e.g., “contextualized personalized prices” may be referred to as “contextual personalized prices” or simply “contextual prices”. A contextualized price is a price that has been calculated based on contextual information. In one embodiment, the contextualized personalized price may include a “surprise offer”. An example calculation is shown below:

Contextualized price=original price

−standard sales discount

−promotional discounts

−customer loyalty points

−reward cash

−coupons

−other incentives

−offer in consumer repository

−suprise offer Eq. 1

The surprise offer, which may also be referred to as an “instant offer”, “instant surprise offer”, or “instant surprise”, is an additional incentive provided by the merchant or retailer based on one or more contexts.

For example, the surprise offer may be made based on multiple customer behaviors, including, but not limited to: purchasing history, customer profile, customer's responses to previous offers or types of offers; customer's personal interest, such as likes or dislikes, customer-provided product reviews or feedback; customer's age; customer's gender; current shopping trip behavior; or other types of contextual information. The surprise offer may bring in a level of intrigue that raises customer interest, and may include a gaming aspect. The special offer may be time limited, which also increases customer interest and may stimulate action the part of the customer to take advantage of an offer while it is still available. In one embodiment, the surprise offer is generated by the contextual marketing platform 102.

Customer behavior may be observed in real time through visuals (e.g., from cameras) and/or actions (e.g., scanning an item) to determine the shopper's level of interest in a particular item. Contextual information about a customer may involve analysis of facial expressions and body language as recorded by store cameras or by an application on the customer's phone, for example. Contextual information may also include information about the customer's location within the store, which may be determined by LiFi or other visual triangulation, by geographic positioning information (e.g., GPS) provided by the customer's mobile device, by motion sensors or other presence detection methods coupled with identification methods (e.g., interaction with the customer's mobile device or via the customer volunteering such information. For example, if a customer lingers in the fragrances section of a department store, it may be inferred that the customer is considering a purchase from that section, in which case the contextual marketing platform 102 may generate a surprise offer, such as “10% off of any fragrance”.

The surprise offer may be generated based on merchant context, such as current inventory count of an item (e.g., the merchant 116 may offer an instant discount to clear an inventory backlog) or other condition. In one embodiment, the contextual marketing platform 102 may consider the promotional elasticity for a particular item and/or a particular store. For example, a retailer may provide to the contextual marketing platform 102 information that a product may be discounted up to 30%. In one embodiment, the contextual marketing platform 102 may treat that as a range, e.g., a 10% discount may be offered to one customer while a 20% discount may be offered to another customer.

The surprise offer may be generated based on other, non-client and non-merchant contexts, such as current weather conditions. For example, if it is currently raining, the contextual marketing platform 102 may provide a sale price on umbrellas or rain boots; if the weather is cold, the contextual marketing platform 102 may provide a surprise discount on winter jackets; if it is a holiday such as mother's day, father's day, valentine's day, etc., the contextual marketing platform 102 may provide surprise offers for items that are popular gifts for those days.

The examples above are representative and not limiting. The contextual marketing platform 102 can accept any type of contextual information and use it to generate a surprise offer. In one embodiment, the contextual marketing platform 102 may generate an offer that is random—e.g., the surprise offer may be for a product or product type chosen at random or may be sent to a customer chosen at random, and so on.

All of the concepts described above may be applied by the contextual marketing platform 102 to generate contextualized personalized offers and/or contextualized personalized product recommendations.

### Contextual Personalized Offer

A contextual personalized offer is a financial incentive that is based on one or more products that the customer may not be looking at specifically but for which there is inferred interest based on contextual information. Whereas the contextualized personalized price is generally provided in response to a request for information about (or other strong indication of interest in) a particular item, a contextualized personalized offer is intended to spark potential interest in other items, including items that the shopper may have interest in but has not thought of at that moment. Examples include items that are related to items in which there has been interest expressed, e.g., a customer shopping for shoes may get a contextualized personalized offer for socks, and items that are entirely unrelated to the items of interest, e.g., a customer shopping for fall clothes in early October may get a contextualized personalized offer for Halloween candy. The contextualized personalized offer may be generated based on many factors, including the factors described herein. A contextual personalized offer provides an offer, coupon, discount price, etc., and may focus on special offers or promotions.

### Contextual Product Recommendations

A contextual product recommendation, which is usually triggered by a request for information, is not necessarily a financial incentive. The contextual product recommendation is not price or promotion driven, but is related to the relative interest in the product or service. The contextual product recommendation may provide information that is not necessarily attached to an offer, and may or may not include a price. A contextual product recommendation could include information about items with alternate styles or colors, items that are accessories, etc. In one embodiment, the shopper's response (if any) to the contextual product recommendation may provide additional context data about the shopper's preferences or interests, for example.

A contextual product recommendation could be a recommendation about a product, a recommendation about a service, or other information. A contextual product recommendation may be a recommendation of another product that is related to the product a user is showing or has shown interest in, e.g., another product having characteristics (color, design, price, quality) that are similar to a product for which the user has shown interest. For example, the recommendation may be for a product that is similar to but cheaper than the current product of interest, or for a product that is more expensive but of a higher quality than the current product of interest. The recommendation may be for a service that is related to the current product or service of interest. For example, the recommendation may be that an item of clothing could be altered or tailored to fit, that a name could be added to a gift card or that gift wrap could be offered.

Offers and Recommendations could be made for products available in a store where the user is shopping, in another store, in a warehouse, or even available directly from manufacturers of a product

Contextual product recommendations are not limited to merchant scenarios and may have usefulness in other situations. For example, when a person visits their bank, the bank may, upon detection that a particular customer is within the bank premises, notify the customer that the bank has low mortgage rates. If the customer uses that bank, the bank may determine what the customer's current mortgage rates are, compare them to the current mortgage rates, and notify the customer that the current mortgage rate being offered by the bank is lower than the customer's current mortgage rate. In another example, a bank may access publically available credit information, determine that the customer has a good credit rating, and notify the customer that his or her credit is so good the he or she qualifies for credit card having an APR of X %.

The contextual prices, personalized offers, and recommendations described herein are not limited only to inventory or services available in a particular physical store. These prices, offers, and recommendations may be generated based on inventory or services available at other stores or warehouses or provided by manufacturers, wholesalers, retailers, distributors, and so on. For example, a personalized price, offer, or recommendation may incorporate manufacturer rebates or other incentives.

The contextual marketing platform 102 can use contextual information to make many kinds of decisions—not only contextual prices, offers, and recommendations, but decisions about whether to try to up-sell (e.g., convince the shopper to buy a more expensive version of the item or to buy more items) or cross-sell (e.g., convince the shopper to buy additional items).

In one embodiment, a merchant may provide a merchant-branded application for a user's mobile device. In one scenario, when the user enters the merchant's premises, a scanner or other hardware within the store may prompt the user to start the merchant-branded application so that the user may take advantage of the contextualized features available. Alternatively, a store beacon may continually generate a message that, when received by the user's mobile device, causes the mobile device to begin executing the merchant-branded application.

### Contextual In-Store Multi-Behavioral Influencer Engine

Because there are so many types of contextual information that could be used to make decisions and initiate actions that influence an in-store customer, and because these decisions and actions can be determined based on a variety of rules, algorithms, equations, and the like, that the concept of a contextual in-store multi-behavioral influencer engine is herein presented. A contextual in-store multi-behavioral influencer engine (herein referred to as a “contextual engine” for brevity) is a processing platform that can analyze contextual information of different types and, based on the analysis results, perform actions. In one embodiment, this may involve one or more of the following:

Identification and collection of contextual information of interest. This may include, but not limited to:
Determining the identity of the shopper and retrieving information associated with that shopper such as the shopper's preferences, loyalty status, shopping history, current location, coupons held by the shopper or for which the shopper is eligible, etc. This may also include determination of the shopper's mood or intent, e.g., via observed behavior, body language, facial expression, or other indicators.
Determining merchant contextual information such as current inventory, merchant specials or promotions, manufacturer or distributor specials or promotions, and other merchant-centric information.
Determining other contextual information such as current date and time, weather conditions, holidays, etc.
   The contextual information above may come from the context information database 104 or from any other source, including but not limited to the mobile device 110, the POS terminal 112, the display unit or kiosk 114, the merchant 116 (e.g., via a merchant backend), sensor(s) 118, other database(s) 120, and network(s) 122. The information collected by the contextual marketing platform 102 may be stored within the context information database 104.

Identification of algorithms, expert knowledge rules, and/or filters to apply to the information. In one embodiment, the context information database 104 may include rules to be applied or not applied based on shopper contextual information, e.g., age, gender, geographical location, clothing size, preferences, etc. For example, coupons for discounts on alcoholic beverages should only be offered to shoppers above the legal age limit for such purchases.

Application of the identified algorithms, rules, and/or filters to the contextual information to generate contextualized, personalized pricing, offers, and product recommendations. This may include generation of a surprise offer as described above. The contextualized, personalized pricing, offers, and product recommendations are then conveyed to the shopper.

### Examples and Use Cases

In one embodiment, a personalized price is generated based on an original price, minus a discount available to all, a redeemed value of loyalty points, rewards, and/or promotion cash, and minus a special contextual offer that is generated and applied in real time.

For example, a shopper scans UPC code of a product, scans a QR code of a product, taps on RFID enabled Price Tag of the product, is visually detected picking up a specific product and recognized through image recognition, or enters specific product SKU # or description on her mobile device. The contextual marketing platform 102 detects this activity, determines the identity of the shopper, and identifies a product in which the shopper has shown particular interest. The contextual marketing platform 102 may then provide to the shopper (e.g., via the shopper's mobile device 110, a POS terminal 112, and/or a display unit/kiosk 114) one or more of the following:
Contextualized, Personalized Price. The contextual marketing platform 102 may provide a discount to the shopper, e.g., as a coupon to be redeemed at checkout, as an instant discount provided at a POS terminal 112, etc.
Contextualized, Personalized Offer. The contextual marketing platform 102 may provide a surprise offer to the shopper, e.g., as a “buy one, get one free” coupon.
Contextualized, Personalized Recommendation. The contextual marketing platform 102 may suggest an item that is related to or compliments an item that the shopper has indicated an intent to purchase.

The following example is intended to be illustrative and not limiting. In one scenario, the contextual marketing platform 102 receives information indicating that a particular user is browsing items in the ladies' bags section of a department store. This may be determined, for example, by detecting the user's presence within that section of the store, e.g., from video cameras or other sensors 118, from GPS data provided by the user's mobile device 110, etc. The contextual marketing platform 102 identifies the user, e.g., from information provided by the user's mobile device 110, from facial recognition software analysis of video data, etc., and retrieves information from the user's profile, such as the user's purchase history, spending habits, preferences, etc. The contextual marketing platform 102 may acquire other types of contextual information of interest from other sources as well.

The contextual marketing platform 102 then identifies algorithms, expert knowledge rules, and filters, which are then applied to the contextual information to generate a contextualized, personalized price, offer, or recommendation. For example, from purchasing behaviors the contextual marketing platform 102 may determine that the user is probably a female, that the user tends to purchase a particular style or design of handbags, and that when the user purchases a handbag, the user occasionally also purchases shoes. The contextual marketing platform 102 may review in-store inventory to determine whether the store has a surplus of particular handbags, which the merchant 116 may be motivated to offer at a discount. Other contextual information that the contextual marketing platform 102 may retrieve and use in the decision making process may include, for example, whether any of the handbag manufacturers are currently offering a discount of rebate on particular handbags, whether certain handbags tend to be purchase with other specific items, and so on.

Based on the application of the algorithms, expert knowledge rules, and/or filters, the contextual marketing platform 102 may provide to the user (e.g., via the user's mobile device 110, via a kiosk 114, via a POS terminal 112, or other means) a contextualized, personalized recommendation, such as: a recommendation for a handbag that matches the user's purchasing history, previous interests, or behavior, and which the store happens to have in surplus; a recommendation for at designer shoe that many previous customers have purchased together or that matches the color and style of a handbag that the customer indicated current interest in (e.g., by checking its price); a free gift wrap service. In addition, the contextual marketing platform 102 may send to the user's mobile device 110 an electronic coupon for a surprise off of 50% off of a second handbag if purchased today. Likewise, the contextual marketing platform 102 may notify the user that if she will receive an additional 5% off of any purchases made in the store today and an additional 10% off of any purchases that are shipped directly from a warehouse to the user's home.

Those skilled in the art will recognize improvements and modifications to the preferred embodiments of the present invention. All such improvements and modifications are considered within the scope of the concepts disclosed herein and the claims that follow.

The following acronyms are used throughout this disclosure:
APR Annual Percentage Rate
ASIC Application Specific Integrated Circuit
CPU Central Processing Unit
DB Database
DSP Digital Signal Processor
FPGA Field-Programmable Gate Array
GPS Global Positioning System
ID Identity/Identifier
LBS Location Based Service(s)
NFC Near-Field Communication
POS Point Of Sale terminal
QR Quick Response (code)
RF Radio Frequency
RFID Radio Frequency Identification Device
SKU Stock-Keeping Unit
UPC Universal Product Code
VR Virtual Reality

1. A method for providing contextualized, personalized pricing, offers, and recommendations to a user, the method comprising:
identifying and collecting contextual information of interest;
identifying algorithms, expert knowledge rules, and/or filters to apply to the contextual information of interest;
applying the identified algorithms, expert knowledge rules, and/or filters to the contextual information of interest to generate a contextualized, personalized price, offer, or recommendation; and
providing or presenting the contextualized, personalized price, offer, or recommendation to the user.

2. The method of claim 1 wherein the contextualized, personalized price, offer, or recommendation includes an original sale price and:
discounts available to all customers;
loyalty points, rewards, and promotion cash available to the user; and/or
a special offer generated in real-time based on contextual information and identified algorithms.

3. The method of claim 1 wherein the contextual information of interest comprises:
user profile information;
information determined to be pertinent or potentially pertinent to the user;
information about past, present, or projected climate or weather conditions;
information about personal events, birthdays, anniversaries, special occasions, social events, public events, holidays, election days, professional events, sports events, performances, and/or social events;
information about natural or emergency events;
information about the state of product inventory and/or available promotions; and/or
information about a state of customer loyalty to a seller.

4. The method of claim 1 wherein the contextual information of interest comprises user profile information and wherein the user profile information includes:
prior history of interest, preferences, purchasing data, and/or shopping behavior of the user; and/or
current indications of interest of the user.

5-9. (canceled)

10. The method of claim 1 wherein the contextual information of interest comprises information about the state of product inventory and/or available promotions and wherein the available promotions are relevant to, associated with, and/or filtered by other contextual information.

11. (canceled)

12. (canceled)

13. The method of claim 1 wherein the contextualized, personalized price, offer, or recommendation is provided or presented to the user within a physical store of a retailer and is associated with an item or service sold by the retailer.

14. The method of claim 13 wherein the contextualized, personalized price, offer, or recommendation is associated with an item or service sold by the retailer but currently unavailable in the physical store.

15. A system for providing contextualized, personalized pricing, offers, and recommendations to a user, the system comprising:
one or more processors; and
memory storing instructions executable by the one or more processors, whereby the system is operable to:
identify and collect contextual information of interest;
identify algorithms, expert knowledge rules, and/or filters to apply to the contextual information of interest;
apply the identified algorithms, expert knowledge rules, and/or filters to the contextual information of interest to generate a contextualized, personalized price, offer, or recommendation; and
provide or present the contextualized, personalized price, offer, or recommendation to the user.

16. The system of claim 15 wherein the contextualized, personalized price, offer, or recommendation includes an original sale price and:
discounts available to all customers;
loyalty points, rewards, and promotion cash available to the user; and/or
a special offer generated in real-time based on contextual information and identified algorithms.

17. (canceled)

18. The system of claim 15 wherein the contextual information of interest comprises:
user profile information;
information determined to be pertinent or potentially pertinent to the user;
information about past, present, or projected climate or weather conditions;
information about personal events, birthdays, anniversaries, special occasions, social events, public events, holidays, election days, professional events, sports events, performances, and/or social events;
information about natural or emergency events;
information about the state of product inventory and/or available promotions; and/or
information about a state of customer loyalty to a seller.

19. The system of claim 15 wherein the contextual information of interest comprises user profile information and wherein the user profile information includes:
prior history of interest, preferences, purchasing data, and/or shopping behavior of the user; and/or
current indications of interest of the user.

20-24. (canceled)

25. The system of claim 15 wherein the contextual information of interest comprises information about the state of product inventory and/or available promotions and wherein the available promotions are relevant to, associated with, and/or filtered by other contextual information.

26. (canceled)

27. (canceled)

28. The system of claim 15 wherein the contextualized, personalized price, offer, or recommendation is provided or presented to the user within a physical store of a retailer and is associated with an item or service sold by the retailer.

29. The system of claim 28 wherein the contextualized, personalized price, offer, or recommendation is associated with an item or service sold by the retailer but currently unavailable in the physical store.

30. (canceled)

31. A non-transitory computer readable medium storing software instructions that, when executed by one or more processors of a system for providing contextualized, personalized pricing, offers, and recommendations to a user, cause the system to:
identify and collect contextual information of interest;
identify algorithms, expert knowledge rules, and/or filters to apply to the contextual information of interest;
apply the identified algorithms, expert knowledge rules, and/or filters to the contextual information of interest to generate a contextualized, personalized price, offer, or recommendation; and
provide or present the contextualized, personalized price, offer, or recommendation to the user.

32-34. (canceled)
